(19) United States
(12) Patent Application Publication
(10) Pub. No.: US 2024/0114878 A1
(43) Pub. Date: Apr. 11, 2024

(54) HEMP-BASED COMPOSITE MATERIAL

(71) Applicant: FELORA HEMP CAT LITTER, Albuquerque, NM (US)

(72) Inventors: Tomas NOVILLO, Castle Rock, CO (US); Dani FONTAINE BILLINGS, Albuquerque, NM (US); Kim KEMPER, Albuquerque, NM (US)

(21) Appl. No.: 18/263,849

(22) PCT Filed: Feb. 1, 2022
(86) PCT No.: PCT/US2022/014685

§ 371 Date: Aug. 1, 2023

Related U.S. Application Data
(60) Provisional application No. 63/144,268, filed on Feb. 1, 2021.

(51) Int. Cl. A01K 1/015

(52) U.S. Cl. CPC A01K 1/0155; A01K 1/0154

(57) ABSTRACT

The enclosed disclosure relates to a composite material formed of a mixture of hemp fibers and a clumping agent, to be used as filler material for a litter box. The different shapes and sizes of the mixture assist informing a clump around the metabolic waste in the litter box to prevent odor from escaping into the atmosphere as well as to make it easier to clean the litter box.

### CROSS-REFERENCE TO RELATED APPLICATION

This application claims priority to U.S. Provisional Application No. 63/144,268, filed on Feb. 1, 2021, the disclosure of which is hereby incorporated herein by reference in its entirety.

### FIELD OF THE DISCLOSURE

The present invention relates to a composite material and more particularly to a composite material to be used as litter box fillers.

### BACKGROUND OF THE DISCLOSURE

A residence keeping domesticated animals such as cats as pets typically has a litter box to collect the metabolic waste of the pets who are free to roam indoors. A litter box has a bottom that is filled with litter box fillers, commonly called “cat litter”, to absorb moisture and odors from the waste. Clay is the most commonly used material in such fillers, along with recycled paper pellets and silica-based crystals. In some cases, baking soda, plant extracts, and/or scented crystals may be included in the filler to better absorb or hide the odors. In some cases, problems arise when the material used as the fillers do not clump easily, causing small pieces to escape the litter box and onto the floor, or the pet does not like the scent of the filler if it is artificially scented. As such, there is a need for fillers having increased clumping capability and odor-neutralizing capability without the drawbacks found in existent fillers.

### SUMMARY OF THE DISCLOSURE

According to the present disclosure composite material to be used as litter box fillers is described. Example embodiments include but are not limited to the following embodiments.

In an Example 1, a filler composite for use in a litter box comprises: a mixture of a clumping agent (e.g., cellulose, cassava root, ijebu gari, bentonite, and the like) and hurd fibers. The clumping agent may be formed as a particulate (e.g., cellulose particles, cassava root particles, ijebu gari particles, bentonite particles), where the clumping agent particles are finer than the hurd fibers, wherein the mixture comprises at least 20% clumping agent by weight.

In an Example 2, further to the filler composite of Example 1, the clumping agent (e.g., cellulose particles) is pelletized into pellets having a larger size than the hurd fibers.

In an Example 3, further to the filler composite of Example 2, each of the pellets is between 10 to 30 mm in length.

In an Example 4, further to the filler composite of Example 1, the clumping agent comprises cellulose particles formed by grinding the hurd fibers.

In an Example 5, further to the filler composite of Example 4, the hurd fibers are ground into particles having a length of between 20 to 70 microns to form the cellulose particles.

In an Example 6, further to the filler composite of Example 1, the mixture comprises 80% hurd by weight.

In an Example 7, further to the filler composite of Example 1, the mixture comprises 20% hurd and 80% clumping agent by weight.

In an Example 8, further to the filler composite of Example 1, the mixture comprises 50% hurd and 50% clumping agent by weight.

In an Example 9, a method of manufacturing a filler composite for use in a litter box comprises: preparing, by a decortication equipment, hurd fibers from hemp plants; grinding, by a grinding mill, the hurd fibers to obtain a clumping agent (e.g., cellulose particles); and mixing the hurd fibers and the clumping agent to obtain the filler composite comprising at least 20% clumping agent by weight.

In an Example 10, further to the method of Example 9, the grinding of the hurd fibers further comprises: grinding, by a first grinding mill via a primary grinding process, the hurd fibers to obtain intermediate-sized clumping agent (e.g., cellulose particles); and grinding, by a second grinding mill via a secondary grinding process, the intermediate-sized clumping agent to obtain final-sized clumping agent that is finer than the intermediate-sized clumping agent.

In an Example 11, the method of Example 9 further comprises: pelletizing, by a pellet mill, the clumping agent (e.g., cellulose particles) to obtain pellets, wherein the filler composite is obtained by mixing the hurd fibers and the clumping agent pellets.

In an Example 12, further to the method of Example 11, each of the clumping agent pellets is between 10 to 30 mm in length.

In an Example 13, further to the method of Example 9, the cellulose particles have a length of between 20 to 70 microns.

In an Example 14, further to the method of Example 9, the filler composite comprises 80% hurd by weight.

In an Example 15, further to the method of Example 9, the filler composite comprises 20% hurd and 80% clumping agent by weight.

In an Example 16, further to the method of Example 9, the filler composite comprises 50% hurd and 50% clumping agent by weight.

In an example 17, a filler composite for use in a litter box comprises: a mixture of a clumping agent and hurd fibers, wherein particles of the clumping agent are finer than the hurd fibers, and wherein the mixture comprises at least 50% hurd fibers by volume or weight.

In an Example 18, further to the filler composite of Example 1 or 17, the mixture comprises no more than 80% hurd fibers by volume or weight.

In an Example 19, further to the filler composite of any one of Examples 1, 17, and 18, the mixture comprises no more than 30% clumping agent by volume or weight.

In an Example 20, further to the filler composite of any one of Examples 1 and 17-19, the mixture comprises no more than 10% baking soda by volume or weight.

In an Example 21, a filler composite for use in a litter box comprises: a mixture of a clumping agent, hurd fibers, and baking soda, wherein particles of the clumping agent are finer than the hurd fibers, and wherein the mixture comprises 60%-80% hurd fibers by volume or weight, 10%-30% clumping agent by volume or weight, and 0%-10% baking soda by volume or weight.

In an Example 22, further to the filler composite of any one of Examples 1 and 17-21, the clumping agent at least partially comprises particles of cassava root.

In an Example 23, further to the filler composite of Example 22, the particles of cassava root are at least partially formed as flakes.

In an Example 24, further to the filler composite of Example 22 or 23, the particles of cassava root are fermented prior to forming the mixture.

In an Example 25, further to the filler composite of Example 24, the particles of cassava root comprise ijebu gari.

In an Example 26, further to the filler composite of any one of Examples 1 and 17-25, the clumping agent at least partially comprises bentonite particles.

In an Example 27, further to the filler composite of Example 26, the clumping agent comprises at least 80% particles of cassava root by volume or weight and no more than 20% bentonite by volume or weight.

In an Example 28, the filler composite of any one of Examples 1 and 17-27, the mixture is configured to form a plurality of clumps in response to adding a liquid into the mixture.

In an Example 29, further to the filler composite of Example 28, each of the plurality of clumps has a minimum length of at least 5 mm.

In an Example 30, further to the filler composite of any one of Examples 1 and 17-29, the mixture comprises additional antimicrobial and biodegradable fiber material to facilitate clumping.

Additional features and advantages of the present disclosure will become apparent to those skilled in the art upon consideration of the following detailed description of the illustrative embodiment exemplifying the best mode of carrying out the disclosure as presently perceived.

### BRIEF DESCRIPTION OF THE DRAWINGS

The detailed description of drawings particularly refers to the accompanying figures in which:

FIG. 1 is an image of a mixture of clumping agent, such as cellulose particles, and hurd fibers according to an embodiment disclosed herein;

FIG. 2 shows an image of a clump of the mixture of FIG. 1 after adding water, according to an embodiment disclosed herein;

FIG. 3 shows a process or method of making the mixture of clumping agent (e.g., cellulose particles) and hurd fibers according to some embodiments disclosed herein;

FIG. 4 shows an image of hurd fibers as formed by grinding the hurd, without adding any clumping agent;

FIG. 5 shows an image of the hurd fibers from FIG. 4 after adding water;

FIG. 6 shows an image of some of the clumping agent (e.g., cellulose pellets) formed according to some embodiments disclosed herein;

FIG. 7 shows an image of some of the hurd fibers formed according to some embodiments disclosed herein;

FIG. 8 shows an image of the mixture of clumping agent, such as cellulose particles, and hurd fibers that clump together after adding water according to embodiments disclosed herein; and

FIG. 9 shows an image of the mixture of clumping agent (e.g., cellulose particles) and hurd fibers, with the cellulose particles processed into cellulose pellets according to some embodiments disclosed herein.

### DETAILED DESCRIPTION

The embodiments of the disclosure described herein are not intended to be exhaustive or to limit the disclosure to the precise forms disclosed. Rather, the embodiments selected for description have been chosen to enable one skilled in the art to practice the disclosure.

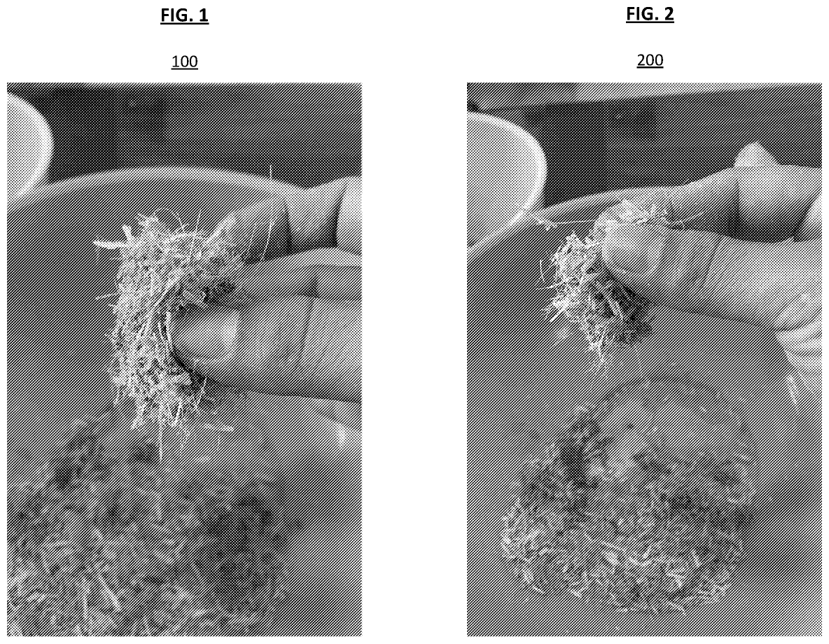

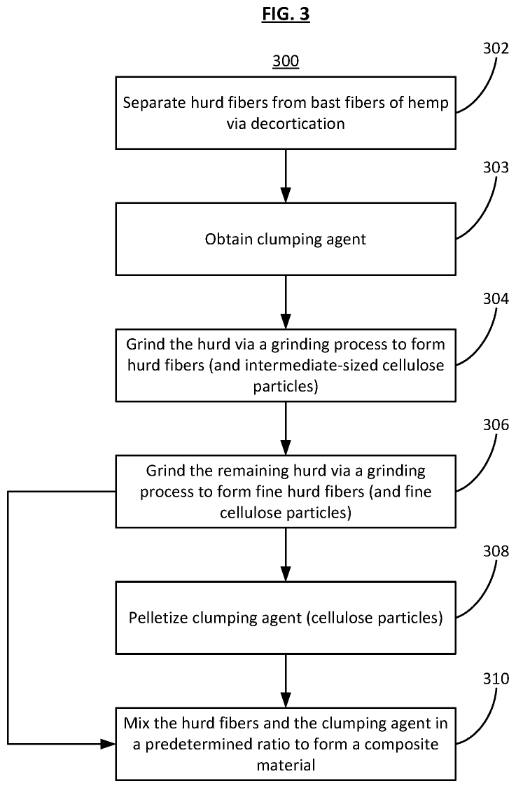

FIG. 1 shows a composite material 100 as disclosed herein, which is a mixture of clumping agent and hurd fibers. For example, as further explained herein, the clumping agent may include particulate such as cellulose particles, cassava root particles, ijebu gari particles, or bentonite particles, which facilitate clumping of the hurd fibers. As used herein, a particle of a material may include any sized or shaped portion representative of the material. FIG. 2 shows the composite material 100 after it forms a clump 200 as a result of having water added into the mixture. The composite material 100 is a mixture including cellulose and hurd fibers in various shapes and sizes. The composite material 100 includes cellulose and hurd fibers in a predetermined ratio. For example, the ratio of clumping agent (e.g., cellulose particles) to hurd in the composite material 100 may be, by volume or weight, 20% clumping agent to 80% hurd, 30% clumping agent to 70% hurd, 40% clumping agent to 60% hurd, 50% clumping agent to 50% hurd, 60% clumping agent to 40% hurd, 70% clumping agent to 30% hurd, 80% clumping agent to 20% hurd, or any other ratio therebetween, such that at least 20% of the content of the composite material 100 is clumping agent (e.g., cellulose particles) and at least 20% of the content of the composite material 100 is hurd. In FIGS. 1 and 2, a mixture of 35% clumping agent (e.g., cellulose particles) and 65% hurd fibers by volume or weight is used.

In examples, the clumping agent (e.g., cellulose particles) and hurd fibers can be obtained by processing a hemp plant. Hemp contains a phloem and fibers around the phloem such that there is an outer fiber portion that is referred to as “bast fiber” and a woody portion, referred to as “hurd” or “shive” located inside the bast fiber. The hurd functions as the core fibers in the hemp stem; as such, it provides protection and support for the hemp plant. The “hurd” as used herein are pieces of the woody core of hemp.

Bast fibers and hurd can be separated from each other by any suitable mechanical or chemical processes. In some examples, the mechanical process involves “decortication” which separates bast fiber from the hurd, after which the hurd can be crushed into smaller particles. In some examples, the chemical process involves “retting” which breaks down the chemical bonds called pectin that hold together the hemp stem, before the bast fiber can be separated from the hurd. Alternatively, in some embodiments, only a portion of the bast fibers are removed from the hurd and/or the bast fibers are not removed from the hurd. In these instances, some or all of the bast fibers are used with the hurd in the processes described herein.

Cellulose particles can be formed from crushing or grinding the hurd by, for example, using a process 300 as described in FIG. 3. In FIG. 3, a composite material forming process 300 is described in accordance with embodiments disclosed herein. In step 302, hemp plants, or more specifically hemp stalks, are obtained, and a separation process, e.g. decortication, is performed to separate the hurd from the bast fibers of the hemp. Any suitable machine such as the decortication equipment may be used to perform this step.

In step 303, a clumping agent may be obtained. In an example, a clumping agent may be obtained by cutting, grinding, or crushing cassava root to form cassava root particles. In another example, a clumping agent may be obtained by fermenting cassava root particles to form ijebu gari particles. In yet another example, a clumping agent may be obtained by processing aluminum silicate to form clay particles (e.g., bentonite particles). In some examples, step 303 is optional.

In step 304, the separated hurd fibers from step 302 may be cut up, ground, or crushed using a grinding process or method in order to reduce the size of the hurd to form finer hurd fibers. The grinding process may include the use of a grinding mill or any other suitable grinding machine. The grinding process results in the formation of intermediate-sized hurd fibers which are then collected. In some examples, the intermediate-sized hurd fibers which are produced by step 304 may produce a clumping agent referred to herein as “intermediate-sized cellulose particles.” In some examples, step 304 is optional and the hurd fibers obtained from the decortication of step 302 are used in the composite material without further grinding to reduce their size. In further examples, step 304 is optional and the clumping agent is obtained via other means, e.g., step 303.

In step 306, the hurd fibers are ground or crushed using another grinding process or method to form fine hurd fibers. In some examples, the fine hurd fibers which are produced by step 306 may produce a clumping agent referred to herein as “fine cellulose particles.” The difference between the grinding processes of steps 304 and 306 lies in the granularity of the resulting product. The grinding process of 304 results in a coarser product with larger particle sizes, whereas the grinding process of 306 results in a finer product with smaller particle sizes. In some examples, step 306 is optional and the hurd fibers obtained from step 302 or 304 are used in the composite material without further grinding to reduce their size. In further examples, steps 304 and 306 are optional and the clumping agent is obtained via other means, e.g., step 303. In some examples, steps 306 and 308 are optional, and step 303 of obtaining the clumping agent may occur before or after step 302 such that the clumping agent is obtained before or after the hurd fibers are separated from bast fibers such that, in step 310, the separated hurd fibers may be mixed with the clumping agent after the separated hurd fibers are ground, for example in step 304 but without forming the intermediate-sized cellulose particles in the process, in order to form the hurd fibers suitable to use in the mixture of the composite material 100.

Step 306 may include a plurality of different grindings. More than one grinding can help the cellulose be more uniform in size, which may help in creating the pellets, in step 308. As such, in some examples, the grinding process includes a primary grinding to obtain semi-fine cellulose particles that are greater in size than the final, fine cellulose particles, and then at least a secondary grinding to form the final, fine cellulose particles, before proceeding to step 308. The primary and secondary grindings of step 306 may be performed by the same or different grinding machines, as long as the secondary grinding results in smaller particle sizes in the final cellulose particles.

It is to be understood that when steps 304 and 306 are performed, steps 304 and 306 may be performed either consecutively or simultaneously using any suitable means of grinding. In some examples, after step 302, the hurd is separated into two sets, with the first set proceeding to step 304 to be ground using the coarser grinding process and the second set proceeding to step 306 to be ground using the finer grinding process. In some embodiments, step 304 is not performed on the second set of hurd and step 306 is not performed on the first set of hurd. Alternatively, in some examples, step 304 is performed on the hurd to produce hurd fibers, and the resulting hurd fibers are separated into two sets of hurd fibers, where the first set of hurd fibers is set aside and only the second set of hurd fibers are processed via step 306 through the grinding process. Any suitable means of controlling the granularity of the resulting product after the grinding process. In some examples, the grinding machine can be mechanically adjusted between steps 304 and 306, or a separate grinding machine can be used to perform optional steps 304 and 306.

In step 308, the clumping agent (e.g., fine cellulose particles formed in step 306) may be pelletized. The clumping agent pellets are formed using any suitable means, e.g., using a pellet mill, e.g., such that the finely ground cellulose particles are collected and combined into a larger, homogeneous mass by compressing the particles together. In some examples, step 308 is optional and the hurd fibers obtained from step 302 or 304 are used in the composite material without further processing. In other examples, the clumping agent obtained from step 306 (e.g., fine cellulose particles) is used in the composite material with the hurd fibers obtain in step 302 or step 304. In still further examples, step 306 and step 308 are optional and the clumping agent is obtained via other means, e.g., step 303, and used in the composite material with the hurd fibers obtain in step 302 or step 304.

In step 310, the hurd fibers from step 302 or step 304 and the clumping agent obtained from step 303, step 304, step 306, or step 308 is mixed together in a predetermined ratio, as explained above in terms of ratio by volume or weight, to form a composite material.

In an alternative process, step 310 can be performed after step 306 to form a composite material by mixing the hurd fibers from step 304 with the clumping agent obtained from step 303 or step 306 in the predetermined ratio. In this process, the clumping agent (e.g., cellulose particles) is not pelletized and as such, pellets are not included in the mixture. As illustrative examples, FIG. 1 shows the composite material 100 formed using step 310 by mixing the hurd fibers and the clumping agent particles, whereas FIG. 9 shows the composite material 100 formed using step 310 by mixing the hurd fibers and the clumping agent pellets.

Alternatively, in some examples, the hurd fibers of sufficient sizes are obtained via decortication in step 302 and thus step 304 may be disregarded. The hurd fibers can be processed through the grinding process of step 306 (which may include a plurality of grindings to further reduce the size of the cellulose particles) to form the clumping agent (e.g., cellulose particles), or the clumping agent may be formed by step 303 (e.g., cassava root particles, ijebu gari particles, or bentonite particles). In some examples, the clumping agent may then be used to form the mixture as per step 310. In other examples, the clumping agent can be formed into pellets (e.g., cellulose pellets) at step 308 and then used in the mixture as per step 310.

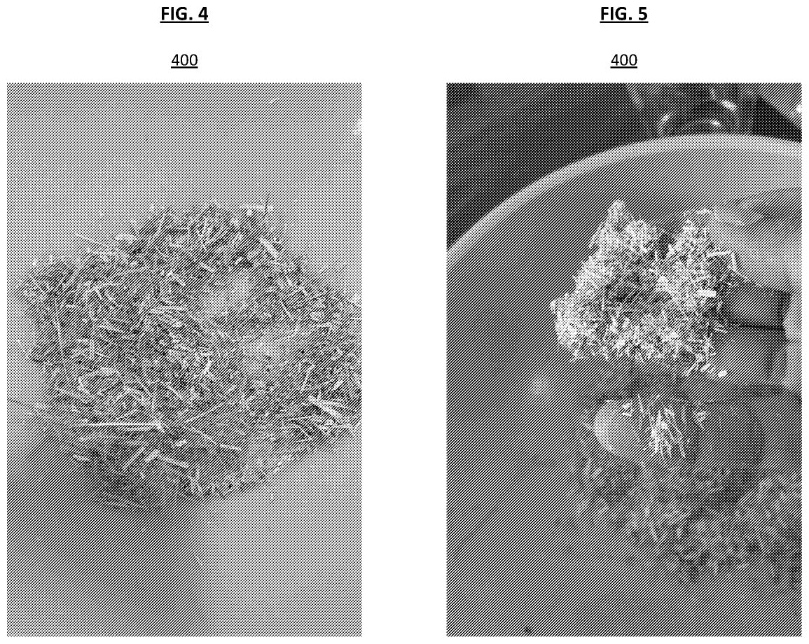

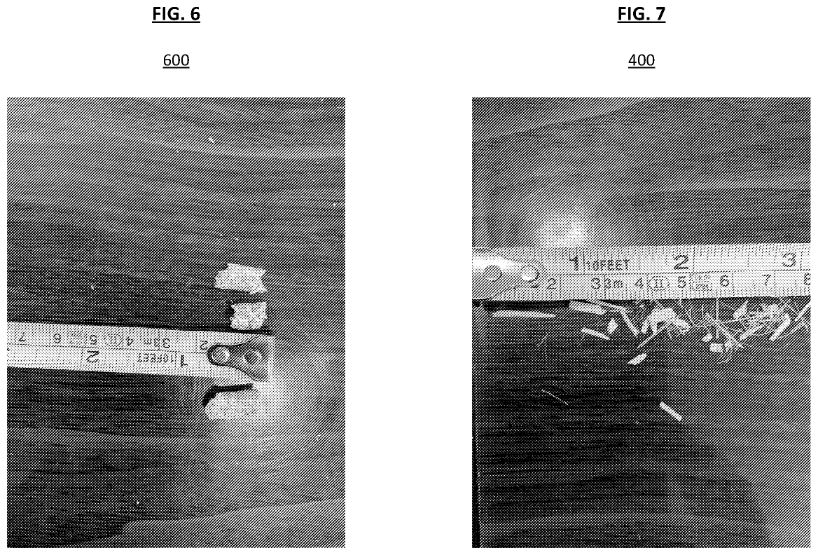

FIG. 4 shows hurd fibers 400 as formed by grinding the hurd in step 304. FIG. 5 shows the hurd fibers 400 after water is added. As illustrated, no clumping or minimal clumping is observed in the hurd fibers 400 even after water is added, unlike the composite material 100 which form the clump 200 with the addition of water, shown in FIG. 2.

FIG. 6 shows examples of cellulose pellets 600 formed in step 308. The length of the pellets 600 may vary between approximately 5 mm to 10 mm, 10 mm to 15 mm, 15 mm to 20 mm, 20 mm to 25 mm, 25 mm to 30 mm, 30 mm to 35 mm, 35 mm to 40 mm, or any range therebetween. The individual cellulose particles that comprise the pellets 600 are even smaller, having a length of less than approximately 100 microns, 80 microns, 60 microns, 40 microns, 20 microns, 10 microns, or any range therebetween.

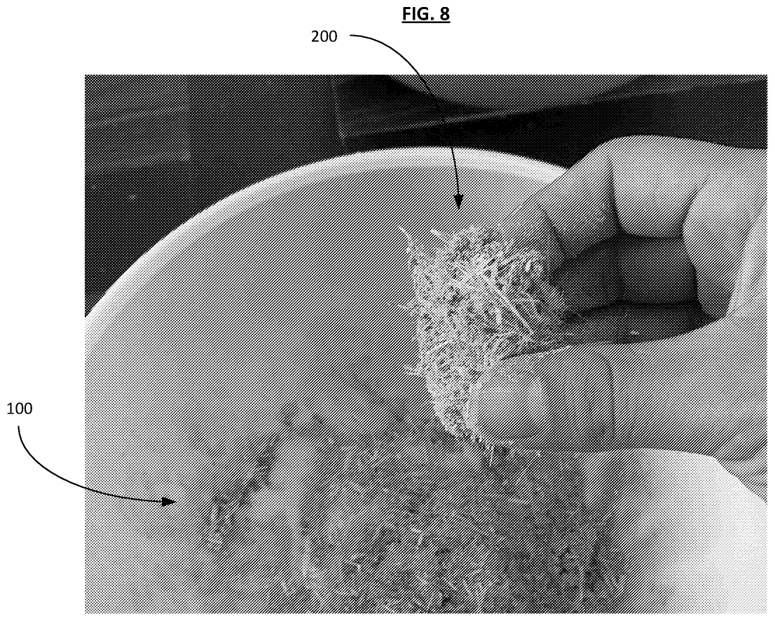

FIG. 7 shows examples of the hurd fibers 400 formed in step 304. The hurd fibers can have a length of at least approximately 3 mm, 5 mm, 7 mm, 10 mm, or any range therebetween.

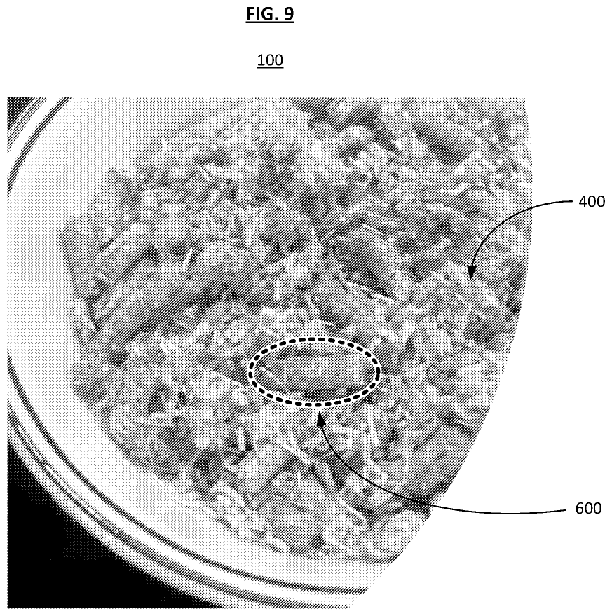

FIG. 8 shows another example of the composite material 100 forming the clump 200 as a result of adding water into the mixture. The composite material 100 in this example includes 50% clumping agent (for example, cellulose particles) and 50% hurd fibers by volume or weight. The cellulose-to-hurd ratio can determine the efficiency of the clumping, i.e., how much of the composite material would be clumped together given the same amount of water being added thereto.

FIG. 9 shows another example of the composite material 100 prior to adding water. The composite material 100 in this example includes the hurd fibers 400 and the cellulose pellets 600 (circled for visibility) as previously described. In this example, the composite material 100 includes 30% cellulose pellets and 70% hurd fiber by volume or weight.

In some examples, the composite material 100 consists solely of the mixture of the clumping agent (such as cellulose particles, cassava root particles, ijebu gari particles, bentonite particles, or the like) and hurd fibers, without any additives such as artificial or chemical additives. In such examples, the mixture of clumping agent and hurd fibers is capable of absorbing any odor coming from the metabolic waste, without additional chemicals such as baking powder or artificial scents. Furthermore, the composite material 100 includes antimicrobial and biodegradable characteristics, due to the properties of the hemp hurd. In some examples, the composite material 100 includes additional fiber material that is also antimicrobial and biodegradable, without any chemical additives. Chemical additives as mentioned herein may include, for example, bonding or adhesive agents to bond together the fibers into pellets, or absorbent material that absorbs moisture from the metabolic waste. Any other types of additives or materials that are not antimicrobial and/or not biodegradable may also excluded from the ingredients of the composite material 100.

In some examples, the composite material 100 is not a mixture but rather comprises layers of different materials. For example, inside the litter box, the composite material 100 is laid out such that the bottom layer that fills the bottom portion of the litter box is filled with clumping agent (e.g., cellulose particles, cassava root particles, ijebu gari particles, bentonite particles, and the like), whereas the top layer that is on top of the bottom layer is filled with hurd fibers. This layout is possible if the clumping agent and hurd fibers are provided in separate individual packages. The user pours the content of the first package (which includes the clumping agent) into the emptied litter box, smoothens the bottom layer to evenly distribute the content of the first package, then pours the content of the second package (which includes the hurd fibers) onto the bottom layer, and finally smoothen it to form the top layer. Advantages of the layered configuration include the ability for the hurd fibers, which may be larger and heavier than the clumping agent, to weigh down on the clumping agent underneath, thereby preventing the clumping agent in the bottom layer from migrating into the atmosphere.

Alternatively, the clumping agent (e.g., cellulose particles) can be prevented from migrating into the atmosphere by pelletizing it into pellets (e.g., cellulose pellets), as disclosed herein. Forming pellets that are larger and heavier than the particles individually has the advantage of enabling the clumping agent to be disposed on the top surface without the clumping agent blowing away from the surface or being inhaled by a person or animal in the proximity.

Using the composite materials as disclosed herein have other advantages over conventional clay cat litter fillers. The fillers disclosed herein that use the certain clumping agents (e.g., cellulose particles, cassava root particles, ijebu gari particles) with the hurd composite material are biodegradable, compostable, odorless, antimicrobial, and significantly less dense than the conventional clay cat litter fillers. For example, the weight of a standard bag size clay cat litter filler is around 35 pounds (or approximately 15.9 kg) and for the same volume, the weight of the cat litter filler using cellulose particles with the hurd composite material is approximately 6 pounds (or approximately 2.7 kg).

In some embodiments, the composite material 100 having a mixture of clumping agent and hurd fibers, where particles of the clumping agent are finer than the hurd fibers (that is, having a smaller length and/or width, for example), use other types of clumping agent besides cellulose, such as cassava root particles or ijebu gari particles. The hurd fibers may be obtained using any suitable method including, but not limited to, decortication of hemp stalks, for example, after which the hurd fibers are mixed with clumping agent. The mixture may include any suitable ratio of clumping agent to hurd fibers. For example, the mixture may include at least 10%, at least 15%, at least 20%, at least 25%, or at least 30%, and up to 40%, clumping agent by weight or volume. For example, the mixture may include at least 50%, at least 55%, at least 60%, at least 65%, at least 70%, at least 75%, or at least 80%, and up to 90%, hurd fibers, by weight or volume. For example, the mixture may include no more than 10%, no more than 7%, no more than 5%, or no more than 3% baking soda by weight or volume. In some examples, the mixture may include clumping agent, hurd fibers, and baking soda such that the percentage by weight or volume may be: 60%-80% hurd fibers, 10%-30% clumping agent, and 0%-10% baking soda. The combination of clumping agent and the hurd fibers facilitate clumping of the mixture when wetted using water, and the baking soda facilitates odor reduction in the mixture during use.

As used herein, the clumping agent may include one or more different materials. In some embodiments, the clumping agent at least partially includes particles of cassava root. The cassava roots may be processed in any suitable means such as fermentation, drying, cooking, etc., to form a suitable material for the mixture. In some examples, the suitable material may be peels, slices, flakes, or chips, etc., as defined by the substantially flat shape. In some examples, obtaining the suitable material may include a fermentation process, in which case the resulting material may be fermented cassava root, also referred to as “ijebu gari,” “ijebu garri,” “gari ijebu,” “white gari,” or simply “garri,” for example. After properly fermented and dried, the cassava root (which may be formed as peels, slices, flakes, chips, or other types of granular particles) is mixed together with the hurd fibers to form the mixture to be used as the composite material 100. As illustrative examples, mixture “A” may include 72% hurd fibers, 22% ijebu gari, and 6% baking soda; mixture “B” may include 68% hurd fibers, 27% ijebu gari, and 5% baking soda; mixture “C” may include 77% hurd fibers, 15% ijebu gari, and 8% baking soda; and mixture “D” may include 60% hurd fibers, 30% ijebu gari, and 10% baking soda. These percentages may be measured by weight or volume.

In some examples, the clumping agent may also include bentonite particles. Bentonite-based clumping cat litter is popular for its property to absorb moisture and liquids such as water or urine, and bentonite increases its volume after coming into contact with liquid, thereby forming clumps. A combination or mixture of bentonite and the aforementioned cassava root particles may be employed as the clumping agent. In some examples, the clumping agent may include at least 70%, at least 75%, at least 80%, at least 85%, at least 90%, or at least 95% cassava root particles by weight or volume, with the remaining being bentonite. In some examples, bentonite may occupy no more than 20% of the total volume or weight of the clumping agent.

The clumping agent may be particulates such that individual particles of the clumping agent are separate and do not clump with each other without wetting or addition of liquid. The individual particles of the clumping agent may have a length of less than approximately 1 mm, less than approximately 0.8 mm, less than approximately 0.5 mm, less than approximately 0.3 mm, less than approximately 0.1 mm, or any value or range therebetween, which is smaller or finer than the aforementioned lengths of the hurd fibers, as shown in FIG. 7.

As previously explained, the mixture of hurd fibers and clumping agent (which may include particles made of cassava roots and bentonite), and in some cases also baking soda, form the composite material 100, which is configured to form a plurality of clumps in response to adding water or other liquid (e.g., urine) into the mixture, or in response to coming into contact with any water. The clumping may be signified by the formation of clumps having a shortest or minimum length of at least 5 mm, at least 10 mm, at least 15 mm, at least 20 mm, at least 25 mm, at least 30 mm, at least 35 mm, at least 40 mm, at least 50 mm, or any other value or range therebetween. As hereby defined, a “shortest length” may be measured between two opposing ends of the clump that is formed, such that the opposing ends can be connected by a line which passes through the center point (for example, the centroid or center of mass) of the clump. In some examples, a “clump” may be defined as a relatively solid structure formed with multiple hurd fibers at least partially and temporarily adhered together as a result of coming into contact with water or moisture.

As shown in FIGS. 2 and 8, a clump may be picked up by hand without falling apart into individual hurd fibers. Clumping, therefore, not only makes it easier to gather and dispose of the used composite material but also traps any odor within each clump. The number of hurd fibers that form such a clump may be greater than 5, greater than 10, greater than 20, greater than 30, greater than 50, greater than 100, or any other number or range therebetween. The amount of water necessary to form such a clump or clumps may be less than 10 mL, less than 20 mL, less than 30 mL, less than 40 mL, less than 50 mL, less than 70 mL, less than 100 mL, or any other value or range therebetween. In some examples, additional antimicrobial and biodegradable fiber material may be included in the mixture to facilitate clumping.

Additional benefits of implementing the composite material as disclosed herein include the aforementioned clumping capability to facilitate formation of solid clumps when liquid is added. The clumps are easier and quicker to clean up and sift through such that only the used hurd fibers (that is, the hurd fibers which are clumped via the clumping agent resulting from liquid being added) can be disposed while the unused hurd fibers (which are still separate and not clumped together) can remain inside the litter box to be used, eliminating the need to replace all of the composite material after a single use. Furthermore, the hurd fibers and particles of the clumping agent do not remain on the body of cats for a prolonged period of time. As such, after using the cat litter with the aforementioned composite material, the cat would not bring the composite material to another location after leaving the litter box, since the particles of the composite material would fall off the cat's body within a proximity of the litter box, thereby minimizing “tracking” of the particles throughout the house. Furthermore, the natural ingredients used in the composite material make it compostable, biodegradable, and environmentally sustainable, as well as having antimicrobial property and facilitating odor reduction.

In certain instances, the composite material as described herein may include multiple packages within a larger package. For example, a single larger package may include a plurality of smaller packages, such that each smaller package fills a single litter box. As such, a user can appropriately fill a litter box using a single smaller package without having to worry about overfilling or underfilling the litter box. In some embodiments, the smaller package may include a volume of the composite material ranging from 0.1 cubic feet to 0.5 cubic feet. Additionally, or alternatively, the larger package may include a number of smaller packages, for a total volume between 0.5 cubic feet to 2.0 cubic feet. However, these are only examples and not meant to be limiting.

In certain examples, each smaller package may be used for a certain period of time prior to disposing of the used composite material and filling the litter box with an unused single smaller package. By designating a useful period of time for each smaller package, a user can be assured that the user is changing the composite material at recommend intervals.

Although the examples and embodiments have been described in detail with reference to certain preferred embodiments, variations and modifications exist within the spirit and scope of the disclosure as described and defined in the following claims.

1. A filler composite for use in a litter box, comprising:
a mixture of a clumping agent and hurd fibers, wherein particles of the clumping agent are finer than the hurd fibers, and wherein the mixture comprises at least 10% clumping agent by volume or weight.

2. A filler composite for use in a litter box, comprising:
a mixture of a clumping agent and hurd fibers, wherein particles of the clumping agent are finer than the hurd fibers, and wherein the mixture comprises at least 50% hurd fibers by volume or weight.

3. The filler composite of claim 1, wherein the mixture comprises no more than 80% hurd fibers by volume or weight.

4. The filler composite of claim 1, wherein the mixture comprises no more than 30% clumping agent by volume or weight.

5. The filler composite of claim 1, wherein the mixture comprises no more than 10% baking soda by volume or weight.

6. A filler composite for use in a litter box, comprising:
a mixture of a clumping agent, hurd fibers, and baking soda, wherein particles of the clumping agent are finer than the hurd fibers, and wherein the mixture comprises 60%-80% hurd fibers by volume or weight, 10%-30% clumping agent by volume or weight, and 0%-10% baking soda by volume or weight.

7. The filler composite of claim 1, wherein the clumping agent at least partially comprises particles of cassava root.

8. The filler composite of claim 7, wherein the particles of cassava root are at least partially formed as flakes.

9. The filler composite of claim 7, wherein the particles of cassava root are fermented prior to forming the mixture.

10. The filler composite of claim 9, wherein the particles of cassava root comprise ijebu gari.

11. The filler composite of claim 1, wherein the clumping agent at least partially comprises bentonite particles.

12. The filler composite of claim 11, wherein the clumping agent comprises at least 80% particles of cassava root by volume or weight and no more than 20% bentonite by volume or weight.

13. The filler composite of claim 1, wherein the mixture is configured to form a plurality of clumps in response to adding a liquid into the mixture.

14. The filler composite of claim 13, wherein each of the plurality of clumps has a minimum length of at least 5 mm.

15. The filler composite of claim 1, wherein the mixture comprises additional antimicrobial and biodegradable fiber material to facilitate clumping.

16. The filler composite of claim 2, wherein the mixture comprises no more than 80% hurd fibers by volume or weight.

17. The filler composite of claim 2, wherein the mixture comprises no more than 10% baking soda by volume or weight.

18. The filler composite of claim 2, wherein the clumping agent at least partially comprises particles of cassava root.

19. The filler composite of claim 18, wherein the particles of cassava root are fermented prior to forming the mixture.

20. The filler composite of claim 2, wherein the clumping agent at least partially comprises bentonite particles.
